(19) United States
(12) Patent Application Publication
(10) Pub. No.: US 2018/0101189 A1
(43) Pub. Date: Apr. 12, 2018

(54) INTEGRATED WIRELESS DISPLAY AND REMOTE CONFIGURATION TRANSMITTER

(71) Applicant: Honeywell International Inc., Morris Plains, NJ (US)

(72) Inventors: Rui Liu, Shanghai (CN); Chuang Huang, Shanghai (CN); Xiangli Zhang, Shanghai (CN); Musen Li, Shanghai (CN); Joseph Pane, North Wales, PA (US)

(21) Appl. No.: 15/289,897

(22) Filed: Oct. 10, 2016

(51) Int. Cl. G05F 1/66; H04W 4/00; G05B 11/01; G05B 19/042

(52) U.S. Cl. CPC G05F 1/66; H04W 4/008; G05B 2219/25428; G05B 19/042; G05B 11/01

(57) ABSTRACT

A system including a field device, a power interface, a short-range wireless transceiver, and at least one processor. The field device is configured to obtain measurements of one or more process variables in an industrial process control and automation system. The power interface is configured to provide 4-20 ma current to the apparatus and the field device. The short-range wireless transceiver is configured to transmit and receive the measurements. The at least one processor is configured to receive, from one or more other devices, a request for access to the measurements and transmit, to the one or more other devices, the measurements.

### TECHNICAL FIELD

This disclosure relates generally to industrial measurement systems. More specifically, this disclosure relates to an apparatus and method for an integrated wireless display and remote configuration transmitter.

### BACKGROUND

Process plants are often managed using industrial process control and automation systems. Conventional control and automation systems routinely include a variety of networked devices, such as servers, workstations, switches, routers, firewalls, safety systems, proprietary real-time controllers, and industrial field devices. Often times, for example, there is a need to have multiple measurement stations at different inlet points of a gas pipeline. Due to the cost and complexity, constraints on the number of measurement stations may result in the number of possible stations to be limited.

One or more embodiments of this disclosures recognizes and takes into account that local human-machine interfaces (HMI) found on industrial field devices, mostly on transmitters (pressure, temperature, level, flow) are monochrome due to the power restrictions in the device. These devices are not as easy to read compared to more sophisticated HMI's that make prudent use of color. HMI's on these devices are typically small, and can be difficult to read. HMI's on these devices can be integral to the field device (that is, they are located with the sensing components of the device). As such, the HMI's are sometimes in a less than convenient location for a person to access. In addition, data entry methods from a local HMI can be limited, such as having a few pushbuttons.

### SUMMARY

A first embodiment of this disclosure provides an apparatus. The apparatus includes a memory element configured to store a device data associated with a field device operating in an industrial process control and automation system. The device data includes measurements of one or more process variables in the industrial process control and automation system. The apparatus also includes a power interface configured to provide 4-20 ma current to the apparatus and the field device. The apparatus also includes a short-range wireless transceiver configured to transmit and receive the device data. The apparatus also includes least one processor configured to receive, from one or more other devices, a request for access to the measurements of the device data and transmit, to the one or more other devices, the device data.

A second embodiment of this disclosure provides a system including a field device, a short-range wireless transceiver, and at least one processor. The field device is configured to obtain measurements of one or more process variables in an industrial process control and automation system. The power interface is configured to provide 4-20 ma current to the apparatus and the field device. The short-range wireless transceiver is configured to transmit and receive the measurements. At least one processor is configured to receive, from one or more other devices, a request for access to the measurements and transmit, to the one or more other devices, the measurements.

A third embodiment of this disclosure provides a method. The method includes providing 4-20 ma current to a field device and a short-range communication unit coupled to the field device in an industrial process control and automation system. The method also includes communicating, by the short-range communication unit coupled to the field device, with one or more other devices. The method also includes receiving, from the one or more other devices, a request for access to the measurements, obtained by the field device, of one or more process variables in the industrial process control and automation system. The method also includes transmitting, to the one or more other devices, the measurements.

Other technical features may be readily apparent to one skilled in the art from the following figures, descriptions, and claims. Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases may be provided throughout this patent document, and those of ordinary skill in the art should understand that in many, if not most instances, such definitions apply to prior, as well as future uses of such defined words and phrases.

### BRIEF DESCRIPTION OF THE DRAWINGS

For a more complete understanding of this disclosure, reference is now made to the following description, taken in conjunction with the accompanying drawings, in which:

FIG. 1 illustrates an example industrial process control and automation system according to this disclosure;

FIG. 2 illustrates an example device for communicating with a wireless display device according to this disclosure;

FIG. 3 illustrates an example system for remote analysis and control of field devices at a gas pipeline according to this disclosure;

FIG. 4 illustrates an exploded view of an example pressure sensor according to this disclosure; and

FIG. 5 illustrates an example process for accessing field device information in an industrial process control and automation system according to this disclosure.

### DETAILED DESCRIPTION

The figures, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

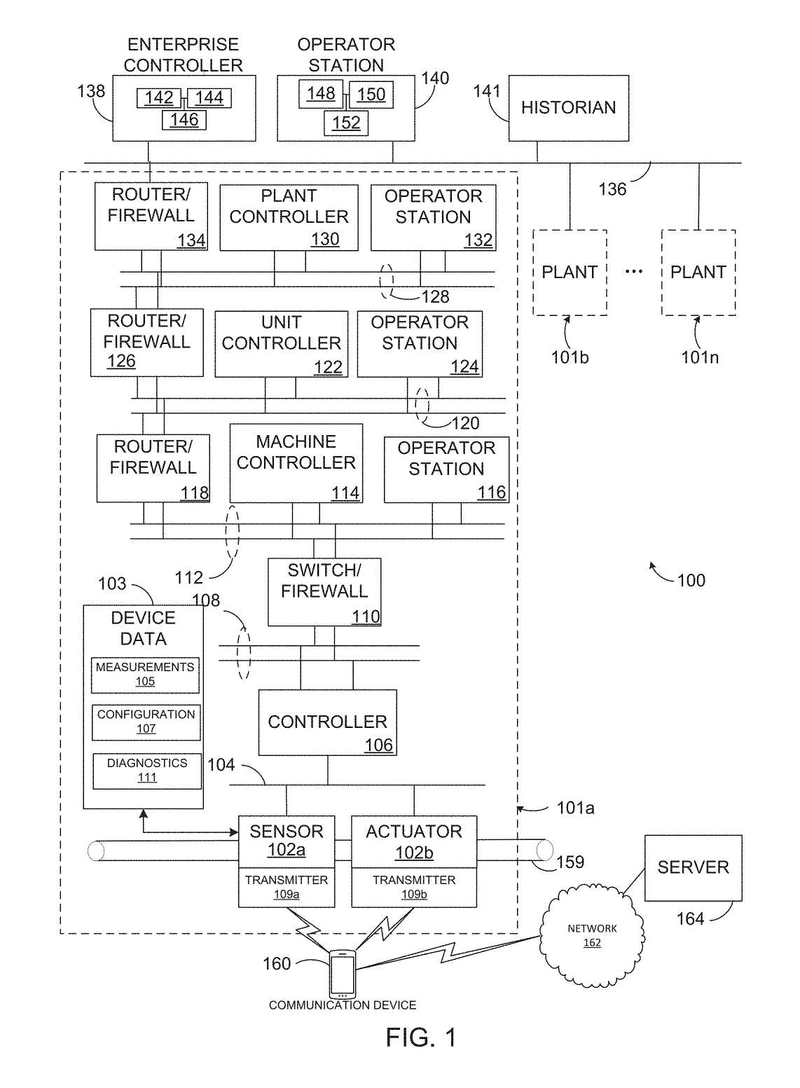

FIG. 1 illustrates an example industrial process control and automation system 100 according to this disclosure. As shown in FIG. 1, the system 100 includes various components that facilitate production or processing of at least one product or other material. For instance, the system 100 is used here to facilitate control over components in one or multiple plants 101a-101n. Each plant 101a-101n represents one or more processing facilities (or one or more portions thereof), such as one or more manufacturing facilities for producing at least one product or other material. In general, each plant 101a-101n may implement one or more processes and can individually or collectively be referred to as a process system. A process system generally represents any system or portion thereof configured to process one or more products or other materials in some manner.

In FIG. 1, the system 100 is implemented using the Purdue model of process control. In the Purdue model, “Level 0” may include one or more sensors 102a and one or more actuators 102b, which collectively may be referred to as field devices as used herein. In one example, the devices can be field mounted, subject to weather conditions outdoor. In another example, the devices can be panel-mounted devices that are mounted indoors on a wall panel. The sensors 102a and actuators 102b represent components in a process system that may perform any of a wide variety of functions.

The sensors 102a and actuators 102b can each include device data 103. The device data 103 can include one or more measurements 105 for a plurality of process variables and at least one configuration 107. For example, the sensors 102a could take the measurements 105 of a wide variety of characteristics in the process system, such as temperature, pressure, or flow rate. The measurement data can be live data that is constantly changing. The device data can also include diagnostic data 111 that can provide diagnostics 111 on the field device, such as, for example, identifying clogged lines. The configuration 107 can include a device identifier. The device identifier can include a unique name, type of device, parameters, etc.

Additionally, the actuators 102b could alter a wide variety of characteristics in the process system. The sensors 102a and actuators 102b could represent any other or additional components in any suitable process system. Each of the sensors 102a includes any suitable structure for measuring one or more characteristics in a process system. Each of the actuators 102b includes any suitable structure for operating on or affecting one or more conditions in a process system. The configuration 107 can include different settings for the field devices 102a-102b, such as, how often to record a measurements, setup data, range limits, alarms, communication preferences, and what measurements to record. At least one network 104 is coupled to the sensors 102a and actuators 102b. The network 104 facilitates interaction with the sensors 102a and actuators 102b. For example, the network 104 could transport measurement data from the sensors 102a, and provide control signals to the actuators 102b. The network 104 could represent any suitable network or combination of networks. As particular examples, the network 104 could represent an Ethernet network, an electrical signal network (such as a HART or FOUNDATION FIELDBUS (FF) network), a pneumatic control signal network, or any other or additional type(s) of network(s).

In the Purdue model, “Level 1” may include one or more controllers 106, which are coupled to the network 104. Among other things, each controller 106 may use the measurements from one or more sensors 102a to control the operation of one or more actuators 102b. For example, a controller 106 could receive measurement data from one or more sensors 102a, and use the measurement data to generate control signals for one or more actuators 102b. Each controller 106 includes any suitable structure for interacting with one or more sensors 102a, and controlling one or more actuators 102b. Each controller 106 could represent, for example, a proportional-integral-derivative (PID) controller or a multivariable controller, such as a Robust Multivariable Predictive Control Technology (RMPCT) controller or other type of controller implementing model predictive control (MPC) or other advanced predictive control (APC). As a particular example, each controller 106 could represent a computing device running a real-time operating system.

Two networks 108 are coupled to the controllers 106. The networks 108 facilitate interaction with the controllers 106, such as by transporting data to and from the controllers 106. The networks 108 could represent any suitable networks or combination of networks. As a particular example, the networks 108 could represent a redundant pair of Ethernet networks.

At least one switch/firewall 110 couples the networks 108 to two networks 112. The switch/firewall 110 may transport traffic from one network to another. The switch/firewall 110 may also block traffic on one network from reaching another network. The switch/firewall 110 includes any suitable structure for providing communication between networks, such as a HONEYWELL CONTROL FIREWALL (CF9) device. The networks 112 could represent any suitable networks, such as an FTE network.

In the Purdue model, “Level 2” may include one or more machine-level controllers 114 coupled to the networks 112. The machine-level controllers 114 perform various functions to support the operation and control of the controllers 106, sensors 102a, and actuators 102b, which could be associated with a particular piece of industrial equipment (such as a boiler or other machine). For example, the machine-level controllers 114 could log information collected or generated by the controllers 106, such as measurement data from the sensors 102a, or control signals for the actuators 102b. The machine-level controllers 114 could also execute applications that control the operation of the controllers 106, thereby controlling the operation of the actuators 102b. In addition, the machine-level controllers 114 could provide secure access to the controllers 106. Each of the machine-level controllers 114 includes any suitable structure for providing access to, control of, or operations related to a machine or other individual piece of equipment. Each of the machine-level controllers 114 could, for example, represent a server computing device running a MICROSOFT WINDOWS operating system. Although not shown, different machine-level controllers 114 could be used to control different pieces of equipment in a process system (where each piece of equipment is associated with one or more controllers 106, sensors 102a, and actuators 102b).

One or more operator stations 116 are coupled to the networks 112. The operator stations 116 represent computing or communication devices providing user access to the machine-level controllers 114, which could then provide user access to the controllers 106 (and possibly the sensors 102a and actuators 102b). As particular examples, the operator stations 116 could allow users to review the operational history of the sensors 102a and actuators 102b using information collected by the controllers 106 and/or the machine-level controllers 114. The operator stations 116 could also allow the users to adjust the operation of the sensors 102a, actuators 102b, controllers 106, or machine-level controllers 114. In addition, the operator stations 116 could receive and display warnings, alerts, or other messages or displays generated by the controllers 106 or the machine-level controllers 114. Each of the operator stations 116 includes any suitable structure for supporting user access and control of one or more components in the system 100. Each of the operator stations 116 could represent, for example, a computing device running a MICROSOFT WINDOWS operating system.

At least one router/firewall 118 couples the networks 112 to two networks 120. The router/firewall 118 includes any suitable structure for providing communication between networks, such as a secure router or combination router/firewall. The networks 120 could represent any suitable networks, such as an FTE network.

In the Purdue model, “Level 3” may include one or more unit-level controllers 122 coupled to the networks 120. Each unit-level controller 122 is typically associated with a unit in a process system, which represents a collection of different machines operating together to implement at least part of a process. The unit-level controllers 122 perform various functions to support the operation and control of components in the lower levels. For example, the unit-level controllers 122 could log information collected or generated by the components in the lower levels, execute applications that control the components in the lower levels, and provide secure access to the components in the lower levels. Each of the unit-level controllers 122 includes any suitable structure for providing access to, control of, or operations related to one or more machines or other pieces of equipment in a process unit. Each of the unit-level controllers 122 could, for example, represent a server computing device running a MICROSOFT WINDOWS operating system. Although not shown, different unit-level controllers 122 could be used to control different units in a process system (where each unit is associated with one or more machine-level controllers 114, controllers 106, sensors 102a, and actuators 102b).

Access to the unit-level controllers 122 may be provided by one or more operator stations 124. Each of the operator stations 124 includes any suitable structure for supporting user access and control of one or more components in the system 100. Each of the operator stations 124 could represent, for example, a computing device running a MICROSOFT WINDOWS operating system.

At least one router/firewall 126 couples the networks 120 to two networks 128. The router/firewall 126 includes any suitable structure for providing communication between networks, such as a secure router or combination router/firewall. The networks 128 could represent any suitable networks, such as an FTE network.

In the Purdue model, “Level 4” may include one or more plant-level controllers 130 coupled to the networks 128. Each plant-level controller 130 is typically associated with one of the plants 101a-101n, which may include one or more process units that implement the same, similar, or different processes. The plant-level controllers 130 perform various functions to support the operation and control of components in the lower levels. As particular examples, the plant-level controller 130 could execute one or more manufacturing execution system (MES) applications, scheduling applications, or other or additional plant or process control applications. Each of the plant-level controllers 130 includes any suitable structure for providing access to, control of, or operations related to one or more process units in a process plant. Each of the plant-level controllers 130 could, for example, represent a server computing device running a MICROSOFT WINDOWS operating system.

Access to the plant-level controllers 130 may be provided by one or more operator stations 132. Each of the operator stations 132 includes any suitable structure for supporting user access and control of one or more components in the system 100. Each of the operator stations 132 could represent, for example, a computing device running a MICROSOFT WINDOWS operating system.

At least one router/firewall 134 couples the networks 128 to one or more networks 136. The router/firewall 134 includes any suitable structure for providing communication between networks, such as a secure router or combination router/firewall. The network 136 could represent any suitable network, such as an enterprise-wide Ethernet or other network or all or a portion of a larger network (such as the Internet).

In the Purdue model, “Level 5” may include one or more enterprise-level controllers 138 coupled to the network 136. Each enterprise-level controller 138 is typically able to perform planning operations for multiple plants 101a-101n and to control various aspects of the plants 101a-101n. The enterprise-level controllers 138 can also perform various functions to support the operation and control of components in the plants 101a-101n. As particular examples, the enterprise-level controller 138 could execute one or more order processing applications, enterprise resource planning (ERP) applications, advanced planning and scheduling (APS) applications, or any other or additional enterprise control applications. Each of the enterprise-level controllers 138 includes any suitable structure for providing access to, control of, or operations related to the control of one or more plants. Each of the enterprise-level controllers 138 could, for example, represent a server computing device running a MICROSOFT WINDOWS operating system. In this document, the term “enterprise” refers to an organization having one or more plants or other processing facilities to be managed. Note that if a single plant 101a is to be managed, the functionality of the enterprise-level controller 138 could be incorporated into the plant-level controller 130.

Access to the enterprise-level controllers 138 may be provided by one or more enterprise desktops (also referred to as operator stations) 140. Each of the enterprise desktops 140 includes any suitable structure for supporting user access and control of one or more components in the system 100. Each of the enterprise desktops 140 could represent, for example, a computing device running a MICROSOFT WINDOWS operating system.

Various levels of the Purdue model can include other components, such as one or more databases. The database(s) associated with each level could store any suitable information associated with that level or one or more other levels of the system 100. For example, a historian 141 can be coupled to the network 136. The historian 141 could represent a component that stores various information about the system 100. The historian 141 could store, for instance, information used during production scheduling and optimization. The historian 141 represents any suitable structure for storing and facilitating retrieval of information. Although shown as a single centralized component coupled to the network 136, the historian 141 could be located elsewhere in the system 100, or multiple historians could be distributed in different locations in the system 100.

In particular embodiments, the various controllers and operator stations in FIG. 1 may represent computing devices. For example, each of the controllers 106, 114, 122, 130, and 138 could include one or more processing devices 142 and one or more memories 144 for storing instructions and data used, generated, or collected by the processing device(s) 142. Each of the controllers 106, 114, 122, 130, and 138 could also include at least one network interface 146, such as one or more Ethernet interfaces or wireless transceivers. In addition, each of the operator stations 116, 124, 132, and 140 could include one or more processing devices 148 and one or more memories 150 for storing instructions and data used, generated, or collected by the processing device(s) 148. Each of the operator stations 116, 124, 132, and 140 could also include at least one network interface 152, such as one or more Ethernet interfaces or wireless transceivers.

In one or more embodiments of this disclosure, sensor 102a and actuator 102b are coupled to transmitters 109a and 109b, respectively. Transmitters 109 can be near field or short-range wireless transmitters designed for use with sensors 102a and actuators 102b in the process industry to transmit device data 102 including certain critical process variables like pressure, temperature, level, flow, energy, and the like. The measurement 105 can be obtained from sensors on a pipeline, tank, etc. The transmitters 109 are loop-powered devices powered by a 4-20 ma current loop. The transmitters 109 could include a transceiver and are configured to send and receive wireless signals.

Various embodiments of this disclosure provide a communication device 160, such as a transmitter or cellular modem, which connects to each sensors 102a and actuators 102b through transmitters 109a and 109b, respectively. In one embodiment, one communication device 160 may connect to multiple sensors 102a and actuators 102b. In other embodiments, a communication device may only connect to a single sensor or actuator.

The communication device 160 collects device data 103 in the form of diagnostics messages, error logs, customer configuration data, and configuration history data from one or more of the sensors 102a and actuators 102b. The communication device 160 connects the sensors 102a and actuators 102b through a wireless connection. In one embodiment, the communication device 160 includes more than one wireless communication interface. In different examples, the communication device 160 may communicate with the sensors 102a and actuators 102b through a near-field or short-range wireless communication protocol, such as, for example, Bluetooth, radio frequency identification, ONE WIRELESS protocol, wireless HART, etc.

In one example embodiment, the transmitters 109 provide a broadcast for discovery by the communication device 160. In an example embodiment, the broadcast can be continuous, substantially continuous, or periodic. The broadcast can be of the device identifier, such as a unique name, or even only a type of device. The broadcast can also include customized information, such as a location. In one example embodiment, the broadcast is transmitted without being requested. In another example, the transmitters 109 provide device information, such as identification, when requested by a communication device 160.

The communication device 160 may communicate the device data 103 received from the sensors 102a and actuators 102b over an Internet connection and update all of this information into a remote server 164 with the device serial number. Any suitable technology to store and sort this data on the host, such as cloud computing, can be used.

In one embodiment, the communications between the field devices and communication device 160 can be encrypted. In another example, authentication is conducted on the communication device 160 to determine whether the communication device 160 has proper access to the field device.

The communication device 160 communicates over a network 162 with the remote server 164. The network 162 generally represents any suitable communication network(s) outside the system 100 (and therefore out of the control of the owners/operators of the system 100). The network 162 could represent the Internet, a cellular communication network, or other network or combination of networks.

The embodiments of this disclosure recognize and take into account that, in some systems, handheld devices are physically wired to the field device via a pair or wires that are hand “clipped” onto the terminals of the field device. To do this the field tech must remove a cover or cap from the field device to expose these terminals to get the handheld connected. When done servicing a device, the field tech must reverse this process by removing the clips and ensuring they do not disrupt the field wires to the host system, and then put the cover/cap back on sufficiently tight to keep moisture or other contaminants out of the field device's internals.

In one embodiment, the field devices 102 operate at a pipeline 159. The pipeline 159 can transport a material, such as a liquid or gas. The pipeline 159 can therefore be a liquid pipeline, gas pipeline, or other type of pipeline. The field devices 102 may be configured to take measurements 105 of the pipeline 159 or the material in the pipeline 159. The field devices 102 may also be configured to affect the flow of gas or liquid in the pipeline through actuators. In other embodiments, the field devices operate at a tank, or other component in the system 100.

Although FIG. 1 illustrates one example of an industrial process control and automation system 100, various changes may be made to FIG. 1. For example, a control and automation system could include any number of sensors, actuators, controllers, operator stations, networks, servers, communication devices, and other components. In addition, the makeup and arrangement of the system 100 in FIG. 1 is for illustration only. Components could be added, omitted, combined, further subdivided, or placed in any other suitable configuration according to particular needs. Further, particular functions have been described as being performed by particular components of the system 100. This is for illustration only. In general, control and automation systems are highly configurable and can be configured in any suitable manner according to particular needs. In addition, FIG. 1 illustrates an example environment in which information related to an industrial process control and automation system can be transmitted to a remote server. This functionality can be used in any other suitable system.

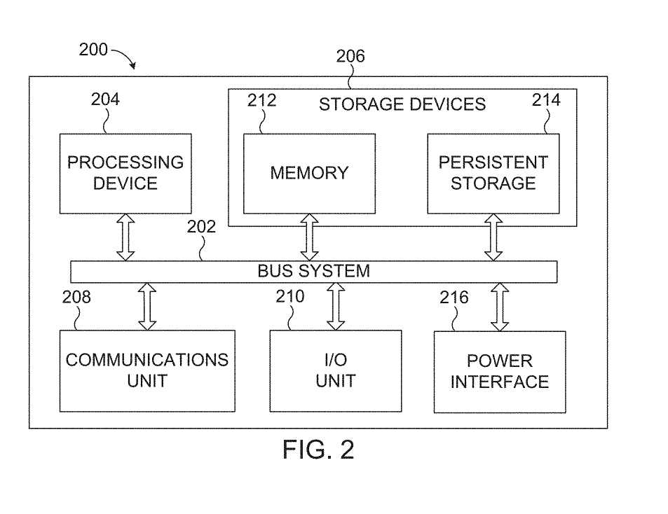

FIG. 2 illustrates an example device for communicating with a wireless display device according to this disclosure. The device 200 could represent, for example, the field devices 102 or the transmitter 109 attached to the field device in the system 100 of FIG. 1. However, the device 200 could be implemented using any other suitable device or system.

As shown in FIG. 2, the device 200 includes a bus system 202, which supports communication between at least one processing device 204, at least one storage device 206, at least one communications unit 208, and at least one input/output (I/O) unit 210. The processing device 204 executes instructions that may be loaded into a memory 212. The processing device 204 may include any suitable number(s) and type(s) of processors or other devices in any suitable arrangement. Example types of processing devices 204 include microprocessors, microcontrollers, digital signal processors, field programmable gate arrays, application specific integrated circuits, and discrete circuitry.

The memory 212 and a persistent storage 214 are examples of storage devices 206, which represent any structure(s) capable of storing and facilitating retrieval of information (such as data, program code, and/or other suitable information on a temporary or permanent basis). The memory 212 may represent a random access memory or any other suitable volatile or non-volatile storage device(s). The persistent storage 214 may contain one or more components or devices supporting longer-term storage of data, such as a ready only memory, hard drive, Flash memory, or optical disc.

The communications unit 208 supports communications with other systems or devices. For example, the communications unit 208 could include a network interface that facilitates communications over at least one short-range or near-field communications, such as, for example, Bluetooth, Ethernet, HART, FOUNDATION FIELDBUS, cellular, Wi-Fi, universal asynchronous receiver/transmitter (UART), serial peripheral interface (SPI) or other network. The communications unit 208 could also include a wireless transceiver facilitating communications over at least one wireless network. The communications unit 208 may support communications through any suitable physical or wireless communication link(s). The communications unit 208 may support communications through multiple different interfaces, or may be representative of multiple communication units with the ability to communication through multiple interfaces. In one embodiment, the communications unit 208 uses short-range communications. In another embodiment, the communications unit 208 uses long-range communications. The communications unit 208 can be one example of transmitters 109a or 109b in FIG. 1.

The I/O unit 210 allows for input and output of data. For example, the I/O unit 210 may provide a connection for user input through a keyboard, mouse, keypad, touchscreen, or other suitable input device. The I/O unit 210 may also send output to a display, printer, or other suitable output device. In another example embodiment, the I/O unit 210 interfaces with different sensor or actuator components.

The device 200 could execute instructions used to perform any of the functions associated with the field device 102. For example, the device 200 could execute instructions that upload device data 103 to and from a communications unit of a communication device 160.

The power interface 216 supplies power to the different components of device 200. For example, power interface 216 could be a 4-20 ma current loop that supplies power to a sensor and transmitter coupled to the sensor.

Although FIG. 2 illustrates one example of a device 200, various changes may be made to FIG. 2. For example, components could be added, omitted, combined, further subdivided, or placed in any other suitable configuration according to particular needs. In addition, computing devices can come in a wide variety of configurations, and FIG. 2 does not limit this disclosure to any particular configuration of computing device.

The embodiments of this disclosure recognize and take into account that current pressure sensors use directly mounted displays to show the data and local buttons to use for configuration. The local display can only show simple data and limited information, and is often not convenient to read as the size is small and there is no backlight because of power limitations. Local buttons also can be difficult to operate, as the operator may need to take high risk if the device is installed at a dangerous place, such as a high tower or a deep well.

The embodiments of this disclosure provide a wireless interface for the pressure sensor. Wireless displays or industry mobile devices can show graphic process parameters, configurations and even large data analysis of the pressure sensor. Through this platform, the user can integrate different application programming protocols to enrich data process capability and improve user experience.

The embodiments herein provide a method for a field device to communicate via a wireless connection to a mobile device that also allows the mobile device to retransmit data from the field to a central system or up to the cloud in a more efficient manner than convention field device protocols provide. Using mobile devices allows other applications to be developed for more local data analytics in the field and allows the field tech to use the more versatile mobile devices rather than single purpose field device handheld configuration devices.

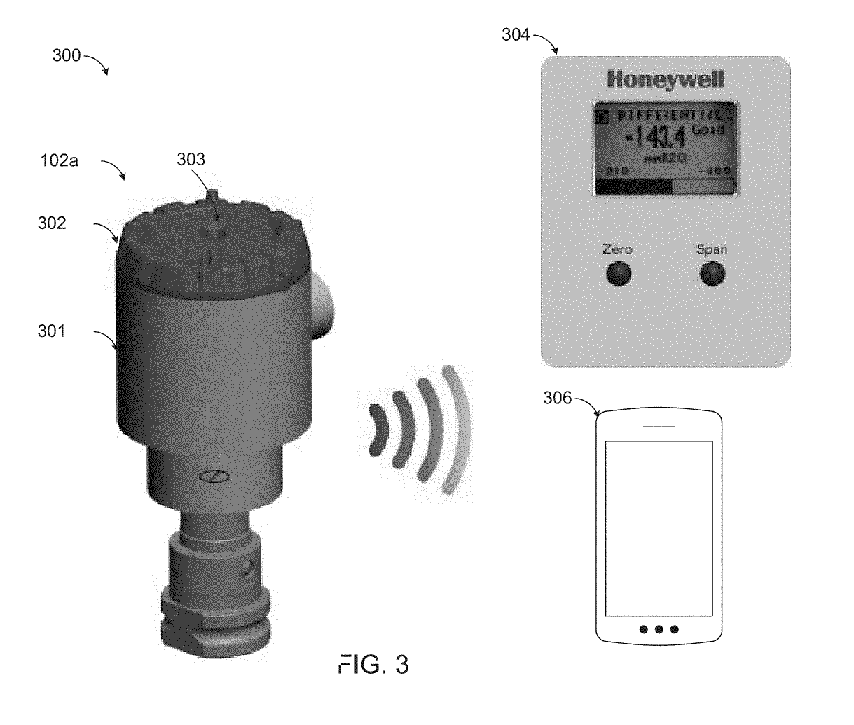

FIG. 3 illustrates an example system 300 for analysis and control of field devices at a gas pipeline according to this disclosure. For ease of explanation, the system 300 is described as being supported by the industrial process control and automation system 100 of FIG. 1. However, the system 300 could be supported by any other suitable system.

In FIG. 3, system 300 includes a sensor 102a, display device 304, and mobile device 306. The sensor 102a includes a housing 301, cap 302, and a visual indicator 303. The visual indicator 303 can be a light, such as a light emitting diode, or a display. The visual indicator 303 can illuminate in response to communications or coupling to the display device 304 or the mobile device 306. The housing 301 can seal the visual indicator 303 at the cap 302 or around the body. The visual indicator 303 helps an operator identify a position of the sensor 102a when receiving the device data from the sensor 102a or when the operator is changing the configuration. The visual indicator 303 can include different patterns or colors to indicate whether data is being transmitted or received or if there are configuration changes being made to the sensor 102a. In another example embodiment, the visual indicator 303 can indicate to a field technician which field device has a critical or non-critical diagnostics present versus sensors that do not have any diagnostics to report.

In one example embodiment, the sensor 102a does not include any display or screen. In this example, only a visual indicator, such as a light emitting diode (LED) exists on the sensor 102a. In another example, no lights or visual indicators of any type exist on the sensor 102a. One or more embodiments of this disclosure provide removing the local display, allowing the field device enclosure to be smaller, lighter weight, less material for less cost, increasing reliability (less components to fail). The embodiments herein allow a device developer to express device parameters, conditions, and diagnostics in a more intuitively, which can lead to field technician safety and productivity gains.

In one or more embodiments, the sensor 102a may communicate with the display device 304 and mobile device 306 through a short-range wireless communication interface. When the display device 304 and mobile device 306 connect to the sensor 102a, the display device 304 and mobile device 306 retrieve device data 103 from the sensor 102a.

In an example embodiment, the display device 304 and mobile device 306 are examples of communication unit 160 of FIG. 1. In an example, mobile device 306 can be a cellular phone, laptop, tablet PC, etc. In another example, display device 304 can be a remote monitoring unit. The display device 304 and mobile device 306 can keep the record of the entire device configuration. The display device 304 and mobile device 306 can track each configuration change in the sensor 102a. The display device 304 and mobile device 306 can monitor the firmware version compatibility and perform a regular firmware upgrade check. The display device 304 and mobile device 306 can also monitor diagnostics, service life, and any alarm conditions of the sensor 102a. The display device 304 and mobile device 306 can use a wireless interface to communicate with the network 162 of FIG. 1.

In different example embodiments, the sensor 102a is a pressure sensor, temperature sensor, gas chromatograph, an ultrasonic sensor, or a control valve. The device data 103 of the field devices 302-310 can include measurements from a pressure sensor, temperature sensor, gas chromatograph, ultrasonic sensors, and control valve.

The sensor 102a can include an electronic gas flow computer. Electronic gas flow computers are microprocessor-based computing devices used to measure and control natural gas streams. There is a variety of configurations available from dedicated (integrated) single board computers to PLC-based multi-run (hybrid) systems. Flow computers can perform multiple functions, including computation of volumetric flow of measured fluid, logging measured and computed data, transmitting real time and historical data to a central location, and performing automated control of the site based on measured values.

The display device 304 and mobile device 306 can greatly improve the field operation of the sensor 102a. Operators do not need to climb to high places or struggle to reach a difficult position to see the display and do the zero and span adjust. By adjusting both zero and span, we may set the instrument for any range of measurement within the manufacturer's limits.

Supply power from a 4-20 mA current loop can improve power efficiency through a DC-DC convertor. This device can be compatible with current industry networks without the maintenance cost of a battery. An integrated modular design avoids exposure of electronics to the environment that may affect signal connection, and reduces the device cost.

Through the wireless interface, the display device 304 and mobile device 306 can integrate more functions for configuration or calculation in a field area. The display device 304 and mobile device 306 can show rich contents such as graphics and data. The sensor 102a can even use third party developed application programming protocols to drive adoption.

Although FIG. 3 illustrates one example of a system 300, various changes may be made to FIG. 3. For example, components could be added, omitted, combined, further subdivided, or placed in any other suitable configuration according to particular needs. In addition, systems for analysis and control of field devices at a gas pipeline can come in a wide variety of configurations, and FIG. 3 does not limit this disclosure to any particular configuration of this system.

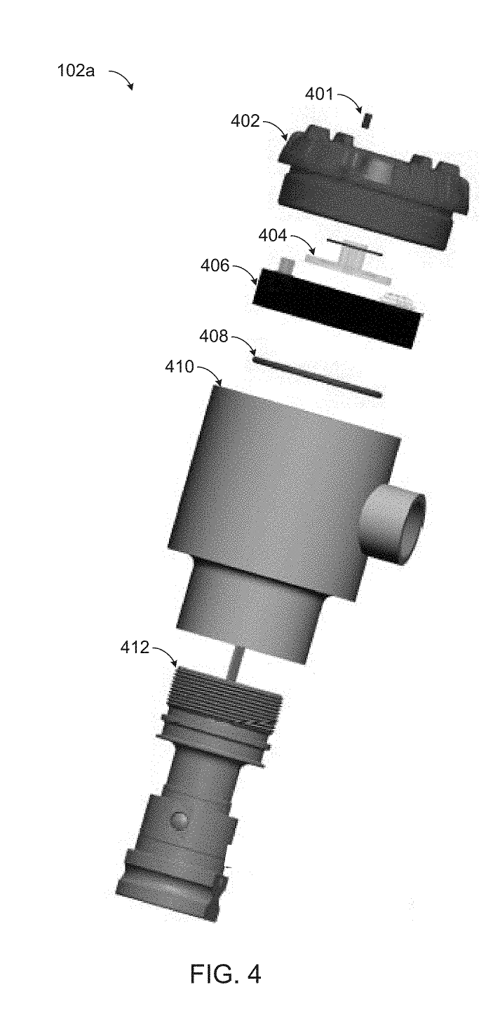

FIG. 4 illustrates an expanded view of an example sensor 102a according to this disclosure. For ease of explanation, the sensor 102a is described as being supported by the industrial process control and automation system 100 of FIG. 1. However, the sensor 102a could be supported by any other suitable system. Additionally, in other example embodiments, the sensor could be a pressure sensor, temperature sensor, gas chromatograph, ultrasonic sensors, or control valve.

In FIG. 4, the sensor 102a includes an antenna 401, a cap 402, a visual indicator 404, a printed wiring assembly (PWA) 406, a seal 408, a terminal 410, and a connector 412. The cap 402, terminal 410, and connector 412 can be arranged together to form a housing. In one example, the housing has a single cavity.

In one example embodiment, this single cavity can include the PWA 406 with bolt and seal components 408 (such as O-ring, etc.) to isolate the PWA 406 from the terminal 410 or sensor components of the terminal. Isolating the PWA 406 reduces a risk of electronics corrosion when a user opens the sensor 102a for transceiver maintenance.

The PWA 406 can include a wireless interface, such as the communications component 208 of FIG. 2. In one example, the wireless interface can be flameproof. The wireless interface includes a wireless function module to communicate with another wireless device. A configuration command can also be received through the wireless interface, which can perform the functions of a local button. In one embodiment, the PWA 406 can be powered by a 4-20 mA current loop.

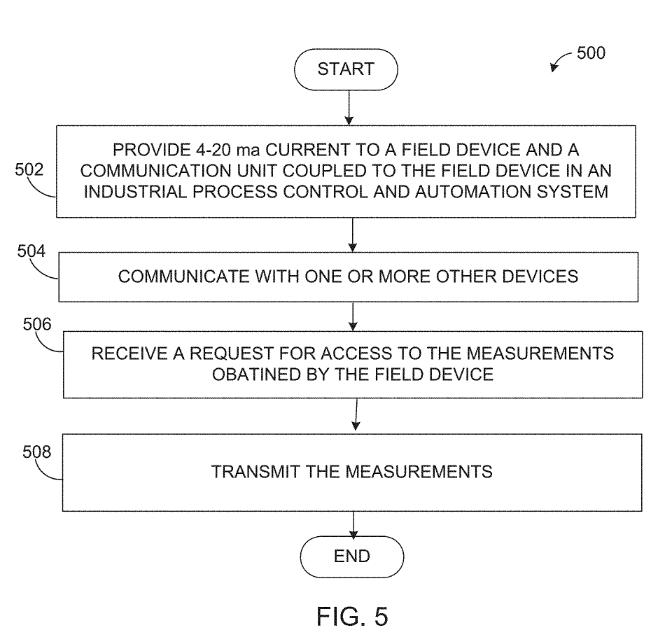

FIG. 5 illustrates an example process 500 for accessing field device information in an industrial process control and automation system according to this disclosure. A processing device, such as a controller, processor, or processing circuitry, can implement different operations in FIG. 5.

As shown in FIG. 5, at operation 502, a processing device is configured to provide a 4-20 ma current to a field device and a communication unit coupled to the field device in an industrial process control and automation system.

At step 504, the processing device is configured to communicate with one or more other devices. This can include the processing device using a transceiver coupled to a field device. The field device could be a sensor 102a or actuator 102b in FIG. 1. In one example, field device is a sensor operating at a pipeline transporting a material in an industrial process control and automation system. The field devices could measure a wide variety of characteristics and process variables in the process system, such as temperature, pressure, or flow rate. In one example embodiment, the devices communicate over a wired interface using one of a Bluetooth or Wi-Fi protocol. The other device can be a display device, a mobile device, or a combination thereof.

At operation 506, the processing device is configured to receive, from the one or more other devices, a request for access to the measurements, obtained by the field device, of one or more process variables in the industrial process control and automation system. The process variables can be associated with the pipeline and the material in the pipeline obtained by the field device. The device can also receive changes to a configuration of the device.

At operation 508, the processing device is configured to transmit, to the one or more other devices, the measurements. Once the device data is received by the other devices, the other devices may perform calculations based on the device data, such as, for example, the volumetric flow of the gas. Based on these computations and calculations, the processing device can determine actions to be taken on other field devices along the gas pipeline. In one or more embodiments, device computations can be performed at a remote place, such as the server 164. In this manner, physical meters can be replaced with soft meters. The different computation instances can be reused across a pipeline. The other devices can also display the data for an operator to review while communicating with the field device and allowing the operator to make configuration changes at that time.

Although FIG. 5 illustrates one example of a process 500 for accessing field device information in an industrial process control and automation system, various changes may be made to FIG. 5. For example, while FIG. 5 shows a series of steps, various steps could overlap, occur in parallel, occur in a different order, or occur any number of times. In addition, the process 500 could include any number of events, event information retrievals, and notifications.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. An apparatus comprising:
a memory element configured to store device data associated with a field device operating in an industrial process control and automation system, the device data including measurements of one or more process variables in the industrial process control and automation system;
a power interface configured to provide 4-20 ma current to the apparatus and the field device;
a short-range wireless transceiver configured to transmit and receive the device data; and
at least one processor configured to:
receive, from one or more other devices, a request for access to the measurements of the device data; and
transmit, to the one or more other devices, the device data.

2. The apparatus of claim 1, wherein:
the field device is a sensor, and
the device data includes the measurements from the sensor measuring one or more process variables of a material in a pipeline or tank.

3. The apparatus of claim 1, wherein the at least one processor is further configured to:
receive, from the one or more other devices, changes to a configuration of the field device; and
perform the changes to the configuration of the field device.

4. The apparatus of claim 1, wherein the at least one processor is further configured to control the short-range wireless transceiver to broadcast an identification of the field device.

5. The apparatus of claim 1, further comprising:
a visual indicator configured to indicate that the field device is currently being accessed by the one or more other devices.

6. The apparatus of claim 1, further comprising:
a visual indicator configured to indicate that the field device includes diagnostics to report.

7. The apparatus of claim 1, further comprising:
a seal configured to isolate the memory element, the transceiver, and the at least one processor from a terminal including pressure sensing components.

8. A system comprising:
a field device configured to obtain measurements of one or more process variables in an industrial process control and automation system;
a communication unit coupled to the field device, the communication unit including a short-range wireless transceiver configured to transmit and receive the measurements;
a power interface configured to provide 4-20 ma current to the field device and the communication unit; and
at least one processor configured to:
receive, from one or more other devices, a request for access to the measurements; and
transmit, to the one or more other devices, the measurements.

9. The system of claim 8, wherein:
the field device is a sensor, and
the measurements from the sensor measure one or more process variables of a material in a pipeline or tank.

10. The system of claim 8, wherein the at least one processor is further configured to:
receive, from the one or more other devices, changes to a configuration of the field device; and
perform the changes to the configuration of the field device.

11. The system of claim 8, wherein the at least one processor is further configured to control the communication unit to broadcast an identification of the field device.

12. The system of claim 8, further comprising:
a visual indicator configured to indicate that the field device is currently being accessed by the one or more other devices.

13. The system of claim 8, further comprising:
a visual indicator configured to indicate that the field device includes diagnostics to report.

14. The system of claim 8, further comprising:
a seal configured to isolate the transceiver and the at least one processor from a terminal including pressure sensing components.

15. A method comprising:
providing 4-20 ma current to a field device and a short-range communication unit coupled to the field device in an industrial process control and automation system;
communicating, by the short-range communication unit coupled to the field device, with one or more other devices;
receiving, from the one or more other devices, a request for access to one or more measurements, obtained by the field device, of one or more process variables in the industrial process control and automation system; and
transmitting, to the one or more other devices, the measurements.

16. The method of claim 15, wherein:
the field device is a sensor, and
the one or more measurements from the sensor measuring one or more process variables of a material in a pipeline or tank.

17. The method of claim 15, further comprising:
receiving, from the one or more other devices, changes to a configuration of the field device; and
performing the changes to the configuration of the field device.

18. The method of claim 15, further comprising:
broadcasting an identification of the field device.

19. The method of claim 15, further comprising:
indicating, using a visual indicator, that the field device is currently being accessed by the one or more other devices.

20. The method of claim 15, further comprising:
indicating, using a visual indicator, that the field device includes diagnostics to report.
